(19) United States
(12) Patent Application Publication
(10) Pub. No.: US 2014/0153804 A1
(43) Pub. Date: Jun. 5, 2014

(54) METHOD FOR EVALUATING IMAGE DATA RECORDS

(71) Applicant: Siemens Aktiengesellschaft, Munich (DE)

(72) Inventors: Kirstin JATTKE, Nuremberg (DE); Sebastian SCHMIDT, Weisendorf (DE); Harald WERTHNER, Fuerth (DE)

(73) Assignee: Siemens Aktiengesellschaft, Munich (DE)

(21) Appl. No.: 14/084,892

(22) Filed: Nov. 20, 2013

(30) Foreign Application Priority Data
Dec. 3, 2012 (DE) 102012222073.9

(51) Int. Cl. G06T 7/00

(52) U.S. Cl. CPC G06T 7/0091; G06T 7/0012
USPC 382/131

(57) ABSTRACT

In an embodiment of a method, a PET image data record, a functional magnetic resonance image data record and a morphological magnetic resonance image data record, the spatial resolution of which is better than that of the functional magnetic resonance image data record, of the target area are recorded with the combination image recording facility, whereby a center of the target structure is localized in the PET image data record. The center is transmitted to the functional magnetic resonance image data record, based on the center the target structure is segmented in the functional magnetic resonance image data record, the segmentation of the target structure in the functional magnetic resonance image data record is transmitted to the morphological magnetic resonance image data record and is improved there within the scope of a fine segmentation.

### PRIORITY STATEMENT

The present application hereby claims priority under 35 U.S.C. §119 to German patent application number DE 10 2012 222073.9 filed Dec. 3, 2012, the entire contents of which are hereby incorporated herein by reference.

### FIELD

At least one embodiment of the invention generally relates to a method for evaluating image data records recorded with a combination image recording facility embodied to record magnetic resonance image data and positron emission tomography image data in a shared coordinate system so as to determine the position and extent of a target structure, in particular a tumor, in a target area of a human body. In addition, at least one embodiment of the invention generally relates to a combination image recording facility and/or a computer program.

### BACKGROUND

Combination image recording facilities, frequently also known as hybrid modalities, are already largely known in the prior art for positron emission tomography (PET). Known combination image recording facilities have the option of recording PET image data together with magnetic resonance image data or computed tomography image data (CT image data). The corresponding emerging image data records are present in the same coordinate system after reconstruction on account of the recording in a single facility. Pure PET image recording facilities are increasingly frequently replaced by combination image recording facilities of this type, since the combination image recording facilities make anatomic and functional information relating to an organ to be examined available.

Devices of this type are frequently used for monitoring and planning therapies. During the radiotherapy of tumors for instance, it is important to accurately localize and delimit the tumor as a target structure in order to be able to effectively plan the irradiation field. During the assessment of the success of the therapy, for instance using RECIST (“Response Evaluation Criteria in Solid Tumors”), the tumor must likewise be exactly delimited in order to achieve correct results.

In this or similar cases, in which the extent of a target structure is to be determined in the human body, it is known to use PET image data records initially in order to locate the target structure, in particular the tumor. This is easily possible on account of the high sensitivity of the PET. The target structure is then segmented again into the CT and/or MR image data records on account of the high spatial resolution. An exact segmentation in the PET image data record is not possible, since the spatial resolution of the PET is relatively poor and the signal-to-noise ratio is often low. The target structures often also accumulate inhomogenously. On account of these problems, the target structures in the PET often have no clear, in particular automatically determinable boundary, so that the segmentation takes place subjectively by the user and brings about significantly different results in the case of different users.

Although segmentation would be more easily possible on morphological CT and/or MR recordings which are produced in the same period of time, nevertheless the target structure in these image data records is frequently not clearly identified or cannot even be clearly delimited.

This problem occurs in particular in lung tumors. In conjunction with this disease, a shift in airways frequently occurs or pressure is exerted onto the surrounding tissue which is then no longer ventilated. This state is referred to as “atelectasis”. The atelectasis appears in the CT or MR image precisely like other soft tissues (with soft tissue density) and thus in the same brightness as the tumor. The tumor can be easily identified within the atelectasis in the PET, but cannot be sufficiently accurately delimited on account of the cited reasons.

A further problem area is brain tumors. The actual tumor can only be delimited with difficulty from surrounding tissue changes (edemas). The tumor is clearly identified in the PET, but can in turn not be easily determined in its spatial extent. The tumor can be better spatially determined in the functional magnetic resonance image data records; the full, required spatial resolution is however only produced from a morphological image.

In order to better determine spatial limits of a tumor or another target structure, it was also already proposed to use specific magnetic resonance contrasts. For instance, reference is made to the article by M. Horn et al., “Dynamic contrast-enhanced MR imaging for differentiation of rounded atelectasis from neoplasm”, JMRI 31: 1364-1370 (2010). With procedures of this type, information relating to the vitality state of the tissue is nevertheless missing, which vitality state can only be provided by the PET.

### SUMMARY

At least one embodiment of the invention is directed to a possibility of obtaining more precise, spatial information relating to the position and extent of a target structure in the human body.

In an embodiment of the invention, a method is disclosed for a PET image data record, a functional magnetic resonance image data record and a morphological magnetic resonance image data record, the spatial resolution of which is better than that of the functional magnetic resonance image data record, of the target area to be recorded with the combination image recording facility, whereby a center, in particular a center area and/or a center point, of the target structure is localized in the PET image data record, the center is transmitted to the functional magnetic resonance image data record, based on the center the target structure is segmented in the functional magnetic resonance image data record, the segmentation of the target structure is transmitted in the functional magnetic resonance image data record to the morphological magnetic resonance image data record and is improved there within the scope of a fine segmentation.

Aside from the method, at least one embodiment of the invention also relates to a combination image recording facility with a control facility embodied in order to implement the method according to the invention. All embodiments with respect to the inventive method can similarly be transmitted to the inventive combination image recording facility, so that the corresponding advantages can also be obtained herewith.

Combination image recording facilities of this type are frequently also referred to as MR PET facilities, and are therefore embodied to simultaneously record PET image data and magnetic resonance image data. Different construction forms are known in the prior art, in which a PET detector ring is in most cases provided in the patient recording, if necessary between components of the magnetic resonance modality. Operation of the combination image recording facility is controlled by a control facility, which in this case implements at least one embodiment of the inventive method, and consequently triggers the combination image recording facility to record the three image data records, and then evaluates these accordingly. To this end, suitable hardware and software components can be used.

At least one embodiment of the invention finally also relates to a computer program, which realizes the steps of at least one embodiment of the inventive method, if it is executed on a computing facility. The computer program can be stored on a data carrier, for instance a CD ROM or suchlike. The statements already relating to the inventive method also apply to the computer program.

### BRIEF DESCRIPTION OF THE DRAWINGS

Further advantages and details of the present invention result from the example embodiments described below and with the aid of the drawing, in which:

FIG. 1 shows a flow chart of the method according to an embodiment of the invention,

FIG. 2 shows a diagram to localize the target structure in an embodiment of the inventive method, and

FIG. 3 shows an embodiment of an inventive combination image recording facility.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In an embodiment of the invention, a method is disclosed for a PET image data record, a functional magnetic resonance image data record and a morphological magnetic resonance image data record, the spatial resolution of which is better than that of the functional magnetic resonance image data record, of the target area to be recorded with the combination image recording facility, whereby a center, in particular a center area and/or a center point, of the target structure is localized in the PET image data record, the center is transmitted to the functional magnetic resonance image data record, based on the center the target structure is segmented in the functional magnetic resonance image data record, the segmentation of the target structure is transmitted in the functional magnetic resonance image data record to the morphological magnetic resonance image data record and is improved there within the scope of a fine segmentation.

It is consequently proposed to use the advantages of a combination image recording facility, here an MR-PET facility, in order to achieve an improved determination of the position and extent of a target structure by automatically evaluating image data records. If image data records with the different modalities are recorded by the combination image recording facility, they are reconstructed in the same coordinate system, in other words voxels with identical coordinates indicate the same anatomical structure. Three image data records now form the basis of the inventive procedure. A PET image data record is firstly recorded, which indicates the target structure in a minimal spatial resolution and poorly delimitable manner. Nonetheless, the target structure is easily identified in the PET image data record. The idea is now to improve the position and extent of the target structure, known roughly from the PET image data record, with the aid of two magnetic resonance image data records, by the already known spatial information relating to the target structure being transmitted between the individual image data records.

Finally the PET image data record is therefore firstly used with its low spatial resolution in order to be able to identify the target structure and to at least spatially specify its center. In order to further state precisely this rough specification, a better resolved functional magnetic resonance image data record is used in a second step. This can be based on a functional biomarker (perfusion, diffusion, etc.), wherein a perfusion image data record is preferred as a target structure in respect of tumors. Provision can generally be made for the functional magnetic resonance image data record to be recorded as a diffusion-weighted magnetic resonance image data record and/or as a Dynamic Contrast Enhancement magnetic resonance data record (DCE image data record) and/or as an Arterial Spin Labeling magnetic resonance data record (ASL image data record) and/or preferably as a perfusion magnetic resonance image data record. Corresponding techniques for recording functional image data records of this type are already known in the prior art.

In this functional MR image data record, the center specifying the rough position of the target structure is transmitted, this being easily possible on account of the corresponding coordinate systems. The center forms the starting point for a segmentation of the target structure, which is easily possible on account of the functional nature of the magnetic resonance image data record. According to the inventive method, a further, morphological magnetic resonance image data record now nevertheless still exists, which consequently shows the anatomy of the human body using high resolution; the target structure is nevertheless not clear. However, on account of the segmentation, very precise spatial information is now provided, which concerns the position and extent of the target structure, so that the morphological magnetic resonance image data record is suited to refining and consequently improving the rougher segmentation in the functional magnetic resonance image data record, on account of the lower spatial resolution. The segmentation is therefore transmitted from the functional magnetic resonance image data record to the morphological magnetic resonance image data record, wherein edges can be sought in the close periphery of the boundaries of the target structure which are determined from the functional magnetic resonance image data record, said edges then reproducing these boundaries with a higher resolution.

An automatable process can be achieved in this way using the special properties and options of the combination image recording facility, said process enabling a highly precise determination of the position and extent of a target structure, which can be used for instance for a subsequently performed diagnosis, therapy planning or the assessment of the success of a therapy.

Provision can concretely be made for the morphological magnetic resonance image data record to be recorded in a proton-density-weighted and/or T1-weighted and/or T2-weighted manner. A T1 weighting lends itself in particular to imaging tumors as a target structure, wherein during the detection of lesions in the lungs a proton density weighting is preferred, since a signal decays rapidly there on account of the various emerging jumps in susceptibility, thereby providing short echo times.

The PET image data record and the magnetic resonance image data records can preferably be recorded at least partially at the same time and/or with a stationary body. The influence of movements of the patient during the examination is thus reduced as far as possible and the image data records are particularly easily comparable.

In order to determine the center, provision can be made for a maximum positron emission tomography image datum of the target structure to be selected and/or the center area to be segmented on a threshold value basis. The determination of the center can therefore take place by the voxel being used with the highest PET signal intensity. A good starting point is in this way provided, without if necessary selecting an excessively large area. It is nevertheless also conceivable for the determination of the center to take place by an area, the center area, by comparison with a threshold value, being selected with a particularly high PET signal intensity. The threshold value is in this way to be selected such that a larger area can indeed be located, but this can further be understood as the center, in other words a center area. Other possibilities for determining a center of the target structure from the PET image data record are naturally also conceivable, for instance a determination of a center point as a focus of a center area, in which the threshold value is exceeded.

For segmentation in the functional magnetic resonance image data record, a region-growing algorithm and/or a random walker algorithm can expediently be used. In this process the region-growing algorithm is preferred, which, moving outward from the center, seeks to locate the actual boundary of the target structure in the functional magnetic resonance image data record. Segmentation algorithms of this type are already largely known in the prior art and need not be shown in more detail here.

In a preferred embodiment of the present invention, provision can be made for the purpose of fine segmentation for an edge to be sought in the morphological magnetic resonance image data record in a search area lying about the edge determined in the functional magnetic resonance image data record. A search area is therefore defined which allows the edge known roughly from the functional magnetic resonance image data record to be located in a more precise position in the morphological magnetic resonance image data record.

It is particularly advantageous here if the search area corresponds to a voxel of the functional magnetic resonance image data record in terms of its size, because the voxel size of the functional magnetic resonance image data record finally reproduces the imprecision, which still exists and can be improved by the morphological magnetic resonance image data record. If a voxel of the functional magnetic resonance image data record corresponds to a length of 5 mm, a voxel nevertheless has a lateral length of 1 mm for the morphological magnetic resonance image data record, so the corresponding edge can be sought in the five voxels of the morphological magnetic resonance image data record which are adjacent to the edge in the functional magnetic resonance image data record. In particular, the search area can include a half voxel expansion of the functional magnetic resonance image data record inward and a half voxel expansion of the functional magnetic resonance image data record outward.

Alternatively or in addition, provision can be made for the size of the search area to be adjustable by a user. A slide bar can be provided herefor for instance in a user interface, where a user can consider the results for differently adjusted search areas.

It is further expedient if a threshold value is determined for detection of an edge in the morphological magnetic resonance image data record as a function of a noise value describing the local noise. By taking account of the noise, a better decision can be made as to when this is an edge and when it is a noise effect. This is particularly relevant since the target structure in the morphological magnetic resonance image data record can only be identified poorly.

It may also be possible for this reason for absolutely no edge to be detected in the search area. The boundary of the target structure located in the functional magnetic resonance image data record is preferably not retained in any of the detectable edges in the search area. No negative effect therefore ensues.

At least one embodiment of the inventive method can be used advantageously in the area of the lungs, if the target structure is a tumor. Consequently, provision can be made for the target area to be the lungs and the morphological magnetic resonance image data record to be recorded in a proton-weighted manner. As already shown above, short echo times prevail in the lungs, thereby offering a proton weighting. Provision can expediently also be made in such a case for the functional magnetic resonance image data record to be recorded as a perfusion magnetic resonance image data record.

Aside from the method, at least one embodiment of the invention also relates to a combination image recording facility with a control facility embodied in order to implement the method according to the invention. All embodiments with respect to the inventive method can similarly be transmitted to the inventive combination image recording facility, so that the corresponding advantages can also be obtained herewith.

Combination image recording facilities of this type are frequently also referred to as MR PET facilities, and are therefore embodied to simultaneously record PET image data and magnetic resonance image data. Different construction forms are known in the prior art, in which a PET detector ring is in most cases provided in the patient recording, if necessary between components of the magnetic resonance modality. Operation of the combination image recording facility is controlled by a control facility, which in this case implements at least one embodiment of the inventive method, and consequently triggers the combination image recording facility to record the three image data records, and then evaluates these accordingly. To this end, suitable hardware and software components can be used.

At least one embodiment of the invention finally also relates to a computer program, which realizes the steps of at least one embodiment of the inventive method, if it is executed on a computing facility. The computer program can be stored on a data carrier, for instance a CD ROM or suchlike. The statements already relating to the inventive method also apply to the computer program.

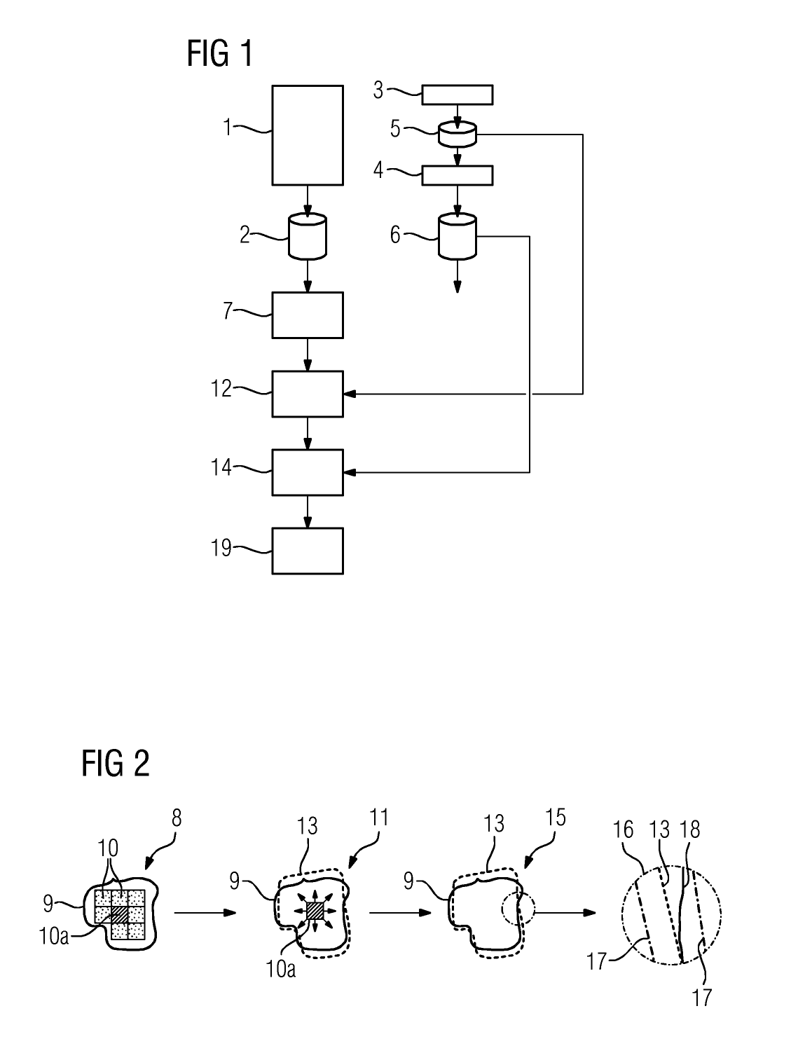

FIG. 1 shows a flow chart of an example embodiment of the method according to the invention, with which in this case the position and extent of a tumor in the lungs are to be automatically determined. This can be used to prepare a therapy, for instance by way of irradiation, but also to classify the tumor or for other tasks which are subsequently to be implemented by a physician.

Since the patient, in particular immobilized, was introduced into and correctly positioned in a combination image recording facility, with which both magnetic resonance image data and also positron emission tomography image data can be recorded, the recording of a PET image data record takes place in step 1, after a tracer, which accumulates in particular in the sought tumor, has been administered. Magnetic resonance image data records 5 and 6 are recorded in steps 3 and 4 in parallel with the recording of the PET image data, i.e. in step 3 a functional magnetic resonance image data record 5, wherein perfusion magnetic resonance imaging is currently used, and in step 4 a morphological magnetic resonance image data record 6, in this case in proton-density-weighted manner. The image data records 2, 5 and 6 are therefore partially recorded at the same time with a non-stationary patient. Since a combination image recording facility is used, the correspondingly reconstructed image data records 2, 5 and 6 are registered with one another, and are therefore present in particular in the same coordinate system.

All image data records 2, 5 and 6, as the target area, relate in this case to the lungs.

The image data records 2, 5 and 6 are now automatically evaluated in order to determine the position and extent of the tumor. To this end, a center, here a center point, of the tumor as a target structure is firstly determined in step 7 from the PET image data record 2. This is explained schematically in more detail with the aid of the first partial image 8 in FIG. 2. The tumor 9 is shown there roughly, and the large voxels 10 of the PET image data record 2 overlay it. A higher PET signal intensity apparently exists at sites within the tumor 9. The voxel 10a which has the highest signal intensity, and consequently the maximum positron emission tomography image datum, is now selected as a center point.

Once the PET image data record 2 is registered with the functional magnetic resonance image data record 5, in which the tumor 9 can also be identified as delimitable, the position of the voxel 10a can also be transmitted into the functional magnetic resonance image data record 5, such as is shown in the second partial image 11 of FIG. 2. This takes place in a step 12 (FIG. 1). Starting from the center point, a region-growing algorithm is also applied in step 12, in order to segment the tumor 9. Since the spatial resolution in the functional magnetic resonance image data record 5 is likewise still not optimal, the boundary 13 is achieved as the result for instance.

In order to further improve this rough segmentation, in a step 14 (FIG. 1), since the magnetic resonance image data records 5, 6 are also registered with one another, the boundary 13 as a segmentation result is now transmitted into the morphological magnetic resonance image data record 6, cf. the partial image 15 in FIG. 2. A search area is then also defined in step 14, the search area corresponding to the voxel size of the functional magnetic resonance image data record 5. This is shown in more detail by the enlarged area 16 in FIG. 2. The search area is defined, moving from the boundary 13 toward both sides, as the half of the voxel extent respectively in the functional magnetic resonance image data record 5, which is visualized by the lines 17. For instance, five to ten voxels of the morphological magnetic resonance image data record 6 can be examined. Within the search area, a corresponding edge which describes the actual boundary 18 of the tumor 9 is now sought in the morphological magnetic resonance image data record 6, in particular in the search directions at right angles to the boundary 13. A threshold value dependent on the local noise in the morphological magnetic resonance image data record 6 is herewith observed, in order to be able to locate an edge.

If an edge is found in the search area, as an improvement in the segmentation this is set as a final boundary of the tumor 9. If no edge is found, the boundary 13, which was obtained during segmentation in the functional magnetic resonance image data record 5, is retained. A further improved segmentation of the tumor 9 is finally obtained at the end of step 14. The method is then terminated in step 19. The improved segmentation specifies the boundaries of the tumor 9 and thus its position and extent.

It is noted again at this point that within the scope of at least one embodiment of the inventive method, three-dimensional image data records 2, 5 and 6 are preferably processed, but the method can also be transferred to the reconstruction of two-dimensional layers, wherein it is then possible to operate in layers, in other words layer by layer.

It is further noted that the described extent of the search area in step 14 can also be realized so as to be adjustable by a user.

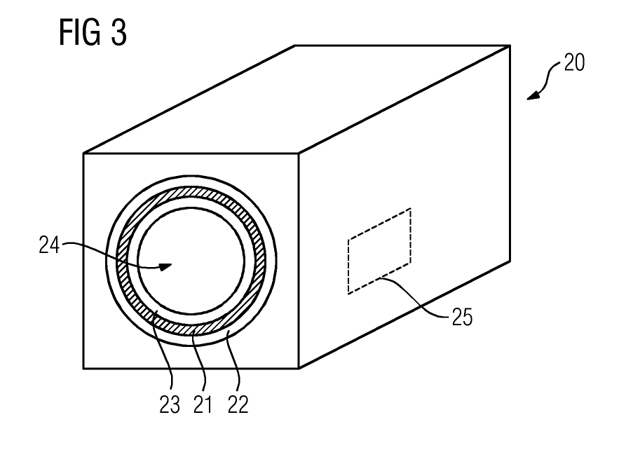

FIG. 3 finally shows, in the form of a basic diagram, an inventive combination image recording facility 20 (MR-PET facility), which is in this case embodied in accordance with the “multi-layer principle”. A PET detector ring 21 is provided here between a gradient coil arrangement 22 and a high frequency coil arrangement 23. These arrangements surround the patient recording 24. Other realization options of such a combination image recording facility 20 are naturally also conceivable.

The combination image recording facility 20 comprises a control facility 25, which is embodied to implement embodiments of the inventive method.

Although the invention was illustrated and described in detail by the preferred example embodiment, the inventive is thus not restricted by the disclosed examples and other variations can be derived herefrom by the person skilled in the art, without departing from the scope of protection of the invention.

What is claimed is:

1. A method for evaluating image data records recorded using a combination image recording facility configured to record magnetic resonance image data and positron emission tomography image data in a shared coordinate system so as to determine position and extent of a target structure in a target area of a human body, the method comprising:
recording a PET image data record, a functional magnetic resonance image data record and a morphological magnetic resonance image data record, the spatial resolution of which is better than that of the functional magnetic resonance image data record, of the target area using the combination image recording facility;
localizing a center of the target structure in the PET image data record;
transmitting the localized center to the functional magnetic resonance image data record;
segmenting, based on localized the center, the target structure in the functional magnetic resonance image data record; and
transmitting the segmentation of the target structure in the functional magnetic resonance image data record to the morphological magnetic resonance image data record.

2. The method of claim 1, wherein the functional magnetic resonance image data record is recorded as at least one of a diffusion-weighted magnetic resonance image data record, a Dynamic Contrast Enhancement magnetic resonance image data record, an Arterial Spin Labeling magnetic resonance image data record and a perfusion magnetic resonance image data record.

3. The method of claim 1, wherein the morphological magnetic resonance image data record is recorded in at least one of a proton-density-weighted manner, a T1-weighted manner and a T2-weighted manner.

4. The method of claim 1, wherein the PET image data record and the magnetic resonance image data record are recorded at least partially at the same time and/or with a stationary body.

5. The method of claim 1, wherein, in order to determine the center, at least one of
a maximum positron emission tomography image datum of the target structure is selected; and
the center area is segmented on a threshold value basis.

6. The method of claim 1, wherein, for segmentation in the functional magnetic resonance image data record, at least one of a region growing algorithm and a random walker algorithm is used.

7. The method of claim 1, wherein an edge is sought in the morphological magnetic resonance image data record for fine segmentation in a search area lying about the edge determined in the functional magnetic resonance image data record.

8. The method of claim 7, wherein the search area at least one of
corresponds to a voxel of the functional magnetic resonance image data record in terms of size, and
is adjustable by a user.

9. The method of claim 7, wherein a threshold value for detecting an edge in the morphological magnetic resonance image data record is determined as a function of a noise value describing local noise.

10. The method of claim 7, wherein the boundary of the target structure located in the functional magnetic resonance image data record is not retained in any detectable edge in the search area.

11. The method of claim 1, wherein the target area is the lungs and the morphological magnetic resonance image data record is recorded in a proton-weighted manner.

12. A combination image recording facility, comprising:
a control facility configured to at least
record a PET image data record, a functional magnetic resonance image data record and a morphological magnetic resonance image data record, the spatial resolution of which is better than that of the functional magnetic resonance image data record, of the target area using the combination image recording facility;
localize a center of the target structure in the PET image data record;
transmit the localized center to the functional magnetic resonance image data record;
segment, based on localized the center, the target structure in the functional magnetic resonance image data record; and
transmit the segmentation of the target structure in the functional magnetic resonance image data record to the morphological magnetic resonance image data record.

13. A computer program, configured to perform the method of claim 1, when run on a computing facility.

14. The method of claim 1, wherein the target structure is a tumor.

15. The method of claim 1, wherein the localizing of the center includes localizing at least one of a center area and a center point of the target structure in the PET image data record.

16. The method of claim 2, wherein the morphological magnetic resonance image data record is recorded in at least one of a proton-density-weighted manner, a T1-weighted manner and a T2-weighted manner.

17. The method of claim 8, wherein a threshold value for detecting an edge in the morphological magnetic resonance image data record is determined as a function of a noise value describing local noise.
